(19) United States
(12) Patent Application Publication
(10) Pub. No.: US 2025/0193509 A1
(43) Pub. Date: Jun. 12, 2025

(54) ELECTRONIC DEVICE, POSITION-INFLUENCING INTERACTION METHOD FOR FLOATING WINDOW AND NON-TRANSITORY COMPUTER READABLE MEDIUM

(71) Applicant: Getac Technology Corporation, New Taipei City (TW)

(72) Inventor: Po-Yang KUO, Taipei City (TW)

(21) Appl. No.: 18/926,705

(22) Filed: Oct. 25, 2024

Related U.S. Application Data
(60) Provisional application No. 63/609,019, filed on Dec. 12, 2023.

(51) Int. Cl. H04N 23/62; G06F 3/0484

(52) U.S. Cl. CPC H04N 23/62; G06F 3/0484

(57) ABSTRACT

The present disclosure provides a position-influencing interaction method for a floating window, which includes steps as follows. When a program is presented as the floating window, a position of the floating window is detected to determine that the floating window is adjacent to a side of an entire display screen of a display device. An interactive component in the floating window is automatically moved to a corresponding side of the floating window in correspondence with the side being adjacent to the floating window.

### RELATED APPLICATIONS

This application claims priority to U.S. Provisional Application Ser. No. 63/609,019, filed Dec. 12, 2023, the disclosure of which are incorporated herein by reference in its entirety.

### BACKGROUND

### Field of Invention

The present invention relates to a device and an operating method thereof, and more particularly, an electronic device, a position-influencing interaction method for a floating window and a non-transitory computer readable medium.

### Description of Related Art

In recent years, there have been more and more mobile programs that support splitting and floating windows, especially tablet applications. However, most programs are designed with right-hand preference, and after switching to a floating window, they will still be presented with an immutable interface. Once the floating window of the program is dragged to the left hand side, it is not only inoperable with the right hand, but it is also difficult to operate with the left hand (and vice versa).

In view of the foregoing, there still exist some problems on the user experience that await further improvement. However, those skilled in the art sought vainly for a solution. Accordingly, there is an urgent need in the related field to solve or circumvent above problems and disadvantages.

### SUMMARY

In one or more various aspects, the present disclosure is directed to an electronic device, a position-influencing interaction method for a floating window and a non-transitory computer readable medium, to solve or circumvent aforesaid problems and disadvantages in the related art.

Some embodiments of the present disclosure are related to a position-influencing interaction method for a floating window. The position-influencing interaction method for the floating window includes steps of: (A) when a program is presented as the floating window, detecting a position of the floating window to determine that the floating window is adjacent to a side of an entire display screen of a display device; and (B) automatically moving an interactive component in the floating window to a corresponding side of the floating window in correspondence with the side being adjacent to the floating window.

In some embodiments of the present disclosure, the step (A) includes: determining whether the floating window is adjacent to a left side or a right side of the entire display screen of the display device according to the position of the floating window.

In some embodiments of the present disclosure, the step (B) includes: automatically rendering the interactive component at a left position in the floating window when the floating window is adjacent to the left side of the entire display screen of the display device.

In some embodiments of the present disclosure, the step (B) includes: automatically rendering the interactive component at a right position in the floating window when the floating window is adjacent to the right side of the entire display screen of the display device.

In some embodiments of the present disclosure, the step (B) includes: rendering the interactive component at an original default position in the floating window when the floating window is positioned in a middle of the entire display screen of the display device.

Some embodiments of the present disclosure are related to an electronic device including a display device, a storage device and a processor. The processor is electrically connected to the storage device and the display device. The display device is configured to display an entire display screen. The storage device is configured to store a program and at least one instruction. The processor configured to access and execute the at least one instruction for: when the program is executed, detecting that the floating window of the program is adjacent to a side of the entire display screen; and automatically setting an interactive component in the floating window to a corresponding side of the floating window in correspondence with the side of the entire display screen being adjacent to the floating window.

In some embodiments of the present disclosure, when the floating window is adjacent to a left side of the entire display screen, the processor automatically sets the interactive component to a left position in the floating window, and when the floating window is adjacent to the right side of the entire display screen, the processor automatically sets the interactive component to a right position in the floating window.

In some embodiments of the present disclosure, when the floating window is positioned in a middle of the entire display screen of the display device, the processor sets the interactive component to an original default position in the floating window.

In some embodiments of the present disclosure, the electronic device further includes a receiving device. The receiving device is electrically connected to the processor, the receiving device is configured to receive operation information inputted through the interactive component, and the processor is configured to perform an action in response to the operation information.

In some embodiments of the present disclosure, the electronic device further includes a camera device. The camera device is electrically connected to the processor, where the interactive component is a virtual button with a shooting extension function, the processor uses the camera device to execute the action in response to the operation information, and the action is related to the shooting extension function.

Some embodiments of the present disclosure are related to a non-transitory computer readable medium to store a plurality of instructions for commanding a computer to execute above-mentioned position-influencing interaction method for the floating window.

Technical advantages are generally achieved, by embodiments of the present disclosure. Through the electronic device, the position-influencing interaction method for the floating window and/or the non-transitory computer readable medium of the present disclosure, aforesaid problems and disadvantages in the related art are solve or circumvent, ensuring that when a user moves the floating window of the program to a side of the entire display screen, the user's hand closer to the side can better operate the interactive component.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the following detailed description of the embodiment, with reference made to the accompanying drawings as follows:

FIG. 1A and FIG. 1B are schematic diagrams of a position-influencing interaction method for a floating window according to some embodiments of the present disclosure;

FIG. 2 is a flow chart of the position-influencing interaction method for the floating window according to one embodiment of the present disclosure; and

FIG. 3 is a block diagram of an electronic device according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

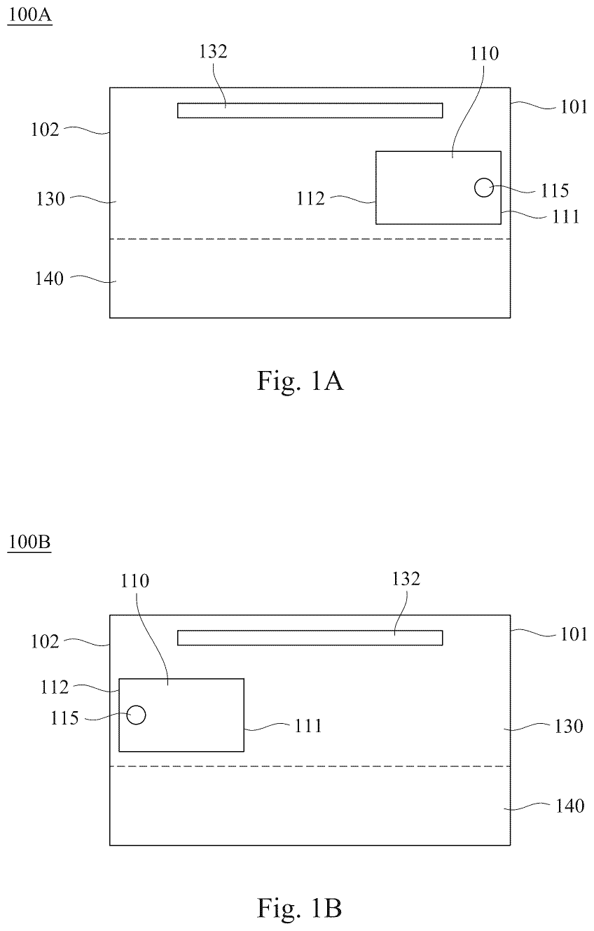

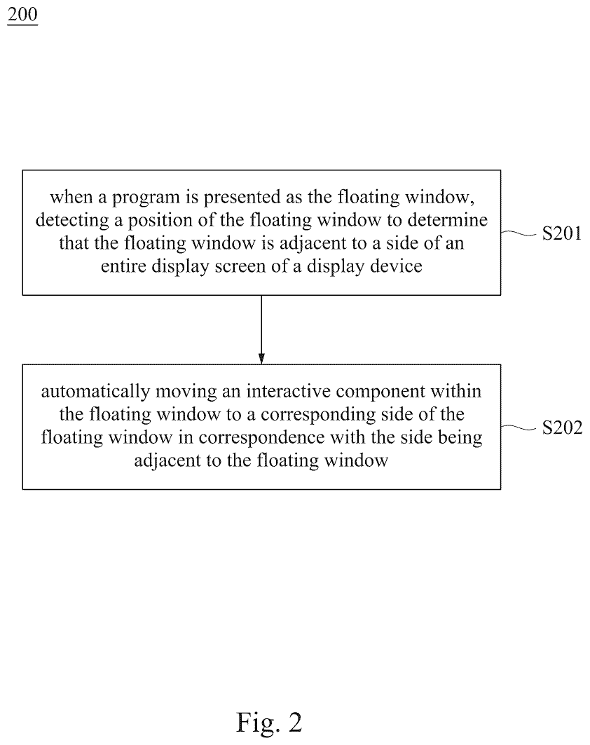

Referring to FIG. 1A, FIG. 1B and FIG. 2, in one aspect, the present disclosure is directed to a position-influencing interaction method 200 for a floating window. This method can be applied to various types of electronic devices and may be applicable or readily adaptable to all technologies. Accordingly, the position-influencing interaction method 200 for the floating window has advantages. Herewith the position-influencing interaction method 200 for the floating window is described below with FIG. 1A, FIG. 1B and FIG. 2.

The subject disclosure provides the position-influencing interaction method 200 for the floating window in accordance with the subject technology. Various aspects of the present technology are described with reference to FIG. 1A, FIG. 1B and FIG. 2. In the following description, for purposes of explanation, numerous specific details are set forth in order to provide a thorough understanding of one or more aspects. It can be evident, however, that the present technology can be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

FIG. 1A and FIG. 1B are schematic diagrams of a position-influencing interaction method for a floating window according to some embodiments of the present disclosure. FIG. 2 is a flow chart of the position-influencing interaction method 200 for the floating window according to one embodiment of the present disclosure. As shown in FIG. 2, the position-influencing interaction method 200 for the floating window includes operations S201 and S202. However, as could be appreciated by persons having ordinary skill in the art, for the steps described in the present embodiment, the sequence in which these steps is performed, unless explicitly stated otherwise, can be altered depending on actual needs; in certain cases, all or some of these steps can be performed concurrently.

The position-influencing interaction method 200 for the floating window may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

Refer to FIG. 1A and FIG. 2. In step S201, when the program is presented as the floating window 110, the position of the floating window 110 is detected to determine that the floating window 110 is adjacent to a side 101 of an entire display screen 100A of a display device. In step S202, an interactive component 115 in the floating window 110 is automatically moved to a corresponding side 111 of the floating window 110 in correspondence with the side 101 being adjacent to the floating window 110, so that the interactive component 115 can be automatically close to the side 101 being adjacent to the floating window 110.

In other words, compared to other sides (e.g., another side 102) of the entire display screen 100A, the floating window 110 is closest to the side 101 of the entire display screen 100A; therefore, compared to other sides (e.g., another side 112) of the floating window 110, the interactive component 115 is automatically moved to the side 111 which is closest to the side 101.

In practice, for example, the entire display screen 100A displays an input interface 140 (e.g., a virtual keyboard), an application interface 130 (e.g., a web browser) and an input area 132 (e.g., search bar or website address bar) of the application interface 130. The interactive component 115 of the floating window 110 can be a virtual button, such as: a barcode scanning function and start scanning button, a barcode detection function and screenshot button, an optical character recognition (OCR) function and screenshot button, or other function operation buttons.

Through the position-influencing interaction method 200 for the floating window, when the user moves the floating window 110 of the program to a side 101 of the entire display screen 100A, the interactive component 115 in the floating window 110 is automatically close to the side 101, the user's hand closer to the side 101 can better operate the interactive component 115.

Refer to FIG. 1A and FIG. 2. In some embodiments of the present disclosure, in step S201, it is determined whether the floating window 110 is adjacent to a left side or a right side of the entire display screen 100A of the display device according to the position of the floating window 110, as a basis of rendering the interactive component 115 in the left or right position in the floating window 110, so as to facilitate the user's left or right hand for operations.

Refer to FIG. 1A and FIG. 2. In some embodiments of the present disclosure, when the floating window 110 is adjacent to the right side of the entire display screen 110A of the display device, the interactive component 115 is automatically rendered at a right position in the floating window 110, so as to facilitate the user's right-hand operation.

Furthermore, refer to FIG. 1B and FIG. 2. In step S201, when the program is presented as the floating window 110, the position of the floating window 110 is detected to determine that the floating window 110 is adjacent to a side 102 of an entire display screen 100B of a display device. In step S202, the interactive component 115 in the floating window 110 is automatically moved to a corresponding side 112 of the floating window 110 in correspondence with the side 102 being adjacent to the floating window 110, so that the interactive component 115 can be automatically close to the side 102 being adjacent to the floating window 110.

In other words, compared to other sides (e.g., another side 101) of the entire display screen 100B, the floating window 110 is closest to the side 102 of the entire display screen 100B; therefore, compared to other sides (e.g., another side 111) of the floating window 110, the interactive component 115 is automatically moved to the side 112 which is closest to the side 102.

In practice, for example, the entire display screen 100B displays an input interface 140 (e.g., a virtual keyboard), an application interface 130 (e.g., a web browser) and an input area 132 (e.g., a search bar or a website address bar) of the application interface 130. The interactive component 115 of the floating window 110 can be a virtual button, such as: a barcode scanning function and start scanning button, a barcode detection function and screenshot button, an OCR function and screenshot button, or other function operation buttons.

Through the position-influencing interaction method 200 for the floating window, when the user moves the floating window 110 of the program to a side 102 of the entire display screen 100B, the interactive component 115 in the floating window 110 is automatically close to the side 102, the user's hand closer to the side 102 can better operate the interactive component 115.

Refer to FIG. 1B and FIG. 2. In some embodiments of the present disclosure, in step S201, it is determined whether the floating window 110 is adjacent to a left side or a right side of the entire display screen 100B of the display device according to the position of the floating window 110, as a basis of rendering the interactive component 115 in the left or right position in the floating window 110, so as to facilitate the user's left or right hand for operations.

Refer to FIG. 1B and FIG. 2. In some embodiments of the present disclosure, when the floating window 110 is adjacent to the left side of the entire display screen 110B of the display device, the interactive component 115 is automatically rendered at a left position in the floating window 110, so as to facilitate the user's left-hand operation.

Refer to FIG. 2. In some embodiments of the present disclosure, when the floating window is positioned in a middle of the entire display screen of the display device, the interactive component is rendered at an original default position in the floating window. In practice, for example, the original default position can be preset to the left position or the right position in the floating window. Since the floating window is neither biased to the left nor to the right in the entire display screen, the interactive component is positioned at the original default position in the floating window, so that the user can use either the left hand or the right hand t to operate the interactive component.

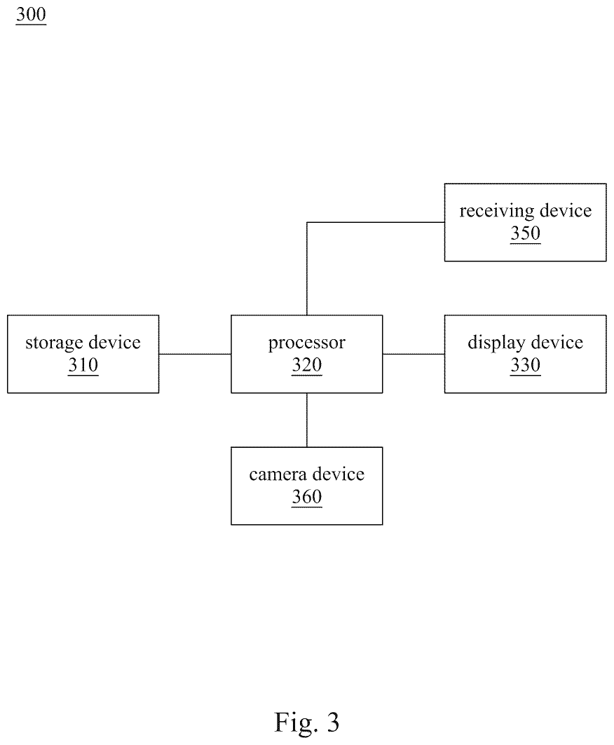

FIG. 3 is a block diagram of an electronic device 300 according to one embodiment of the present disclosure. As shown in FIG. 3, the electronic device 300 includes a storage device 310, a processor 320, a display device 330, a receiving device 350 and a camera device 360. For example, the electronic device 300 can be a tablet computer, a smart phone, a notebook computer or another computer device, the storage device 310 can be a hard drive, a flash memory or another storage equipment, the processor 320 can be a central processor, a controller or another circuit, the display device 330 can be a flat display device or a curved display device, the receiving device 350 can be a touch circuit or another input device, and the camera device 360 can be a photography lens module or the like.

In structure, the processor 320 is electrically connected to the storage device 310 and the display device 330, the receiving device 350 is electrically connected to the processor 320, and the camera device 360 is electrically connected to the processor 320. It should be understood that in the embodiments and the scope of the patent application, the description of “electrically connected” can generally refer to one component being indirectly electrically coupled to another component through other components, or one component being directly electrically coupled to another component without trough other components. For example, the storage device 310 can be a built-in storage device that is directly electrically connected to the processor 320, or the storage device 310 can be an external storage device that is indirectly connected to the processor 320 through connection lines.

Refer to FIG. 1A and FIG. 3. In some embodiments of the present disclosure, the display device 330 displays or has the entire display screen 100A, the storage device 310 stores a program and at least one instruction, and the processor 320 access and execute the at least one instruction for: when the program is executed, detecting that the floating window 110 of the program is adjacent to a side 101 of the entire display screen 100A; and automatically setting an interactive component 115 in the floating window 110 to a corresponding side 111 of the floating window 110 in correspondence with the side 101 of the entire display screen 100A being adjacent to the floating window 110 of the program. In practice, for example, the electronic device 300 can be a tablet computer, which often requires the user to hold it with both hands. The interactive component 115 automatically moves to a side 111 closest to the side 101, so that the user can hold the electronic device 300 without leaving the hand to operate the interactive component 115. As long as the program supports the floating window 110 that can be dragged, the electronic device 300 can automatically switch the position of the interactive component 115 in the floating window 110 accordingly.

Refer to FIG. 1A and FIG. 3. In some embodiments of the present disclosure, when the floating window 110 is adjacent to the right side of the entire display screen 100A, the processor 320 automatically sets the interactive component 115 to a right position in the floating window 110. Thus, even if the electronic device 300 is held only by the right hand, it can be ensured that the right hand can operate the interactive component 115 while maintaining the freedom of the left hand.

Refer to FIG. 1B and FIG. 3. In some embodiments of the present disclosure, the display device 330 displays or has the entire display screen 100B, the storage device 310 stores a program and at least one instruction, and the processor 320 access and execute the at least one instruction for: when the program is executed, detecting that the floating window 110 of the program is adjacent to a side 102 of the entire display screen 100B; and automatically setting an interactive component 115 in the floating window 110 to a corresponding side 112 of the floating window 110 in correspondence with the side 102 of the entire display screen 100B being adjacent to the floating window 110 of the program. In practice, for example, the electronic device 300 can be a tablet computer, which often requires the user to hold it with both hands. The interactive component 115 automatically moves to a side 112 closest to the side 102, so that the user can hold the electronic device 300 without leaving the hand to operate the interactive component 115 by fingers. As long as the program supports the floating window 110 that can be dragged, the electronic device 300 can automatically switch the position of the interactive component 115 in the floating window 110 accordingly.

Refer to FIG. 1B and FIG. 3. In some embodiments of the present disclosure, when the floating window 110 is adjacent to the left side of the entire display screen 100B, the processor 320 automatically sets the interactive component 115 to a left position in the floating window 110. Thus, even if the electronic device 300 is held only by the left hand, it can be ensured that the left hand can operate the interactive component 115 while maintaining the freedom of the right hand.

Refer to FIG. 3. In some embodiments of the present disclosure, when the floating window is positioned in a middle of the entire display screen of the display device 330, the processor 320 sets the interactive component to an original default position in the floating window. In practice, for example, the original default position can be preset to the left position or the right position in the floating window. Since the floating window is neither biased to the left nor to the right in the entire display screen, the interactive component is positioned at the original default position in the floating window, so that the user can use either the left hand or the right hand t to operate the interactive component.

Refer to FIG. 1A, FIG. 1B and FIG. 3. In some embodiments of the present disclosure, the user can input operation information to the receiving device 350 through the interactive component 115, and the receiving device 350 receives the operation information inputted through the interactive component 115, so that the processor 320 can perform an action in response to the operation information. In practice, for example, the receiving device 350 and the display device 330 can be integrated into a touch screen to display the interactive component 115 of the floating window 110. The user touches the interactive component 115 through the touch screen, so that the touch screen can receive the operation information, and the processor 320 can perform the action in response to the operation information. In practice, for example, the program stored in the storage device 310 executed by the processor 320 supports the floating window 110 that can be dragged. Under the function of the original input interface 140 (e.g., a virtual keyboard), the user can use one or more additional functions through the interactive component 115 of the floating window 110.

Refer to FIG. 1A, FIG. 1B and FIG. 3. In some embodiments of the present disclosure, the interactive component 115 is a virtual button with a shooting extension function, the processor 320 uses the camera device 360 to execute the action in response to the operation information, and the action is related to the shooting extension function. In practice, for example, the program stored in the storage device 310 can be a program related to extended shooting functions (e.g., a barcode scanning program, a barcode detection program, an optical character recognition program or the like), it supports the floating window 110 that can be dragged, the interactive component 115 of the floating window 110 can be a shooting extension function button, such as: a barcode scanning function and start scanning button, a barcode detection function and screenshot button, an OCR function and screenshot button or another virtual button.

In view of the above, technical advantages are generally achieved, by embodiments of the present disclosure. Through the electronic device 300 and/or the position-influencing interaction method 200 for the floating window of the present disclosure, the problems and disadvantages in the related art are solve or circumvent, ensuring that when a user moves the floating window 110 of the program to a side of the entire display screen, the user's hand closer to the side can better operate the interactive component 115.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A position-influencing interaction method for a floating window, comprising steps of:
(A) when a program is presented as the floating window, detecting a position of the floating window to determine that the floating window is adjacent to a side of an entire display screen of a display device; and
(B) automatically moving an interactive component in the floating window to a corresponding side of the floating window in correspondence with the side of the entire display screen being adjacent to the floating window.

2. The position-influencing interaction method for the floating window of claim 1, wherein the step (A) comprises:
determining whether the floating window is adjacent to a left side or a right side of the entire display screen of the display device according to the position of the floating window.

3. The position-influencing interaction method for the floating window of claim 2, wherein the step (B) comprises:
automatically rendering the interactive component at a left position in the floating window when the floating window is adjacent to the left side of the entire display screen of the display device.

4. The position-influencing interaction method for the floating window of claim 2, wherein the step (B) comprises:
automatically rendering the interactive component at a right position in the floating window when the floating window is adjacent to the right side of the entire display screen of the display device.

5. The position-influencing interaction method for the floating window of claim 2, wherein the step (B) comprises:
rendering the interactive component at an original default position in the floating window when the floating window is positioned in a middle of the entire display screen of the display device.

6. An electronic device, comprising:
a display device configured to display an entire display screen;
a storage device configured to store a program and at least one instruction; and
a processor electrically connected to the storage device and the display device, and the processor configured to access and execute the at least one instruction for:
when the program is executed, detecting that a floating window of the program is adjacent to a side of the entire display screen; and
automatically setting an interactive component in the floating window to a corresponding side of the floating window in correspondence with the side of the entire display screen being adjacent to the floating window.

7. The electronic device of claim 6, wherein when the floating window is adjacent to a left side of the entire display screen, the processor automatically sets the interactive component to a left position in the floating window, and when the floating window is adjacent to a right side of the entire display screen, the processor automatically sets the interactive component to a right position in the floating window.

8. The electronic device of claim 6, wherein when the floating window is positioned in a middle of the entire display screen of the display device, the processor sets the interactive component to an original default position in the floating window.

9. The electronic device of claim 6, further comprising:
a receiving device electrically connected to the processor, the receiving device configured to receive an operation information inputted through the interactive component, and the processor configured to perform an action in response to the operation information.

10. The electronic device of claim 9, further comprising:
a camera device electrically connected to the processor, wherein the interactive component is a virtual button with a shooting extension function, the processor uses the camera device to execute the action in response to the operation information, and the action is related to the shooting extension function.

11. A non-transitory computer readable medium to store a plurality of instructions for commanding a computer to execute a position-influencing interaction method for a floating window, and the position-influencing interaction method for the floating window comprising steps of:
(A) when a program is presented as the floating window, detecting a position of the floating window to determine that the floating window is adjacent to a side of an entire display screen of a display device; and
(B) automatically moving an interactive component in the floating window to a corresponding side of the floating window in correspondence with the side of the entire display screen being adjacent to the floating window.

12. The non-transitory computer readable medium of claim 11, wherein the step (A) comprises:
determining whether the floating window is adjacent to a left side or a right side of the entire display screen of the display device according to the position of the floating window.

13. The non-transitory computer readable medium of claim 12, wherein the step (B) comprises:
automatically rendering the interactive component at a left position in the floating window when the floating window is adjacent to the left side of the entire display screen of the display device.

14. The non-transitory computer readable medium of claim 12, wherein the step (B) comprises:
automatically rendering the interactive component at a right position in the floating window when the floating window is adjacent to the right side of the entire display screen of the display device.

15. The non-transitory computer readable medium of claim 12, wherein the step (B) comprises:
rendering the interactive component at an original default position in the floating window when the floating window is positioned in a middle of the entire display screen of the display device.
